(19) United States
(12) Patent Application Publication
(10) Pub. No.: US 2011/0210523 A1
(43) Pub. Date: Sep. 1, 2011

(54) CHUCK FOR HOLDING PRECISION COMPONENTS

(75) Inventors: Marian Trocki, Columbus, IN (US); Sam Lawson, Columbus, IN (US)

(73) Assignee: CUMMINS INTELLECTUAL PROPERTIES, INC., Minneapolis, MN (US)

(21) Appl. No.: 12/939,158

(22) Filed: Nov. 3, 2010

Related U.S. Application Data
(60) Provisional application No. 61/257,615, filed on Nov. 3, 2009.

(51) Int. Cl. B23B 31/30

(52) U.S. Cl. 279/4.12

(57) ABSTRACT

The disclosure provides a chuck assembly for precisely holding a workpiece, such as a tool or part. The chuck assembly includes a piston mounted for movement and a set of jaws mounted for pivotal movement. Movement of the piston causes pivotal movement of the set of jaws.

### CROSS REFERENCE TO RELATED APPLICATIONS

This invention claims benefit of priority from the U.S. Provisional Patent Application Ser. No. 61/257,615 filed on Nov. 3, 2009, the entire contents of which are hereby incorporated herein by reference.

### TECHNICAL FIELD

This invention relates to a chuck for holding components, and specifically to a chuck used to hold components in a machine for precision working of components.

### BACKGROUND

Chucks are mechanisms removably hold and/or secure a part or tool. Some chucks operate by manipulation by the operator to clamp onto and secure and/or unsecure a part or tool. For example, a conventional three-jaw chuck requires the operator to loosen the jaws to insert the item to be held and to tighten the jaws to clamp down on and secure the item. Other bit holders may automatically clamp onto and secure an item when the user inserts the item into the chuck, or require an action by the operator, such as twisting the chuck body by hand or using an external device, such as a key or other tool, to secure and/or unsecure an object to be held.

### SUMMARY

The invention is directed to a chuck assembly for precisely holding a workpiece. In an embodiment consistent with the claimed invention, a chuck assembly includes a piston mounted for movement and a set of jaws mounted for pivotal movement. Movement of the piston causes pivotal movement of the set of jaws.

According to a more specific exemplary embodiment, the chuck the piston may include a tapered portion to apply a driving force to at least one jaw of the set of jaws. The tapered portion also may be frusto-conically shaped.

According to other more specific exemplary embodiments, the chuck assembly may include a passageway fluidly connected to a chamber including the piston. The movement of the piston may include a clamping motion during which the jaws move toward a closed position with increasing pressure of fluid in the passageway. The chuck assembly may include a mandrel, which may have a tapered shape and/or include a fluid passageway for actuating the piston. A mandrel also may include an extending member in sliding engagement with the piston.

According to yet another more specific exemplary embodiment, the chuck assembly may further include a housing portion having a centerline axis and the piston and jaws are provided in the housing. In another specific embodiment, and each of the jaws may pivot in a radial plane extending radially from the centerline axis of the housing.

Other features, elements, characteristics and advantages of the present invention will become more apparent from the following detailed description of preferred embodiments of the present invention with reference to the attached drawings.

### BRIEF DESCRIPTION OF THE DRAWINGS

FIG. 1 is an exploded view of the chuck assembly according to an exemplary embodiment.

FIG. 2 is a perspective view of the chuck assembly.

FIG. 3 is a cross-sectional view of the along the longitudinal axis of the chuck assembly.

FIG. 4 is an enlarged cross-sectional view of a chuck housing end of the assembly shown in FIG. 3.

FIG. 5 is a cross-sectional view of a chuck assembly similar to FIG. 3.

FIG. 6A is a cross section side view of a mandrel of a chuck assembly according to an exemplary embodiment.

FIG. 6B is a rear view of the mandrel shown in FIG. 6A.

FIG. 6C is a side view of the mandrel shown in FIG. 6A.

FIG. 6D is an enlarged view of the circled area of FIG. 6A.

FIGS. 7A to 7D shows various views of a piston of a chuck assembly according to an exemplary embodiment.

FIG. 8A is a perspective view of a jaw of a chuck assembly according to an exemplary embodiment.

FIG. 8B is a top view of the jaw shown in FIG. 8A.

FIG. 8C is a cross section view of the jaw shown in FIG. 8A.

FIGS. 8D and 8F are side views of the jaw shown in FIG. 8A.

FIG. 8E is a rear view of the jaw shown in FIG. 8A.

FIGS. 9A to 9F show various views of a housing of a chuck assembly according to an exemplary embodiment.

### DETAILED DESCRIPTION

Finish grinding of some injection system components, i.e. injector plungers or needles, requires special work holding and clamping methods to achieve required roundness and end-to-end run out specifications. Some injector needles are quite long, e.g. greater than 130 mm, and small in diameter, e.g. diametral cross section of 4 mm. Needles often include other portions or diametral sections along its length having larger diameters, such as 6 mm and 8 mm. This needle configuration requires a chuck that can receive these extra long parts and have enough chuck jaw travel to accommodate the diametral differences of the different needle sections, and yet be accurate and repeatable to less than 0.005 mm when clamping work pieces.

There do not appear to be any standard off-the-shelf clamping devices that perform this work holding function sufficiently to satisfy the above-mentioned requirements.

The chuck of the present invention is specifically dedicated to provide proper work holding during needle grinding operations to achieve required roundness and run out specifications. The chuck of the present invention is designed to enable grinding of either end of the needle, also referred to as the needle valve element or plunger. The part to be machined can be simply turned around endwise if necessary. Conventional grinding operations require two distinct operations with different chucks for each end of the needle. The chuck change over between the two grinding operations was minimized and without any additional work holding.

Major features of the chuck of the present invention include enabling greater precision machining with accuracy and repeatability (run-outs) of less than 0.005 mm. In addition, the chuck accepts parts (needles) with large length to diameter (L/D) ratios, can hold parts up to 150 mm in length, and has a jaw that opens through a wide range, for example, 6 mm, i.e. a jaw opening of 3 to 9 mm, or 4 to 10 mm, etc. Conventional chucking devices of similar accuracy have an opening range of 0.2 mm.

The chuck of the present invention effectively holds small works, such as needle valve elements or plungers used in fuel injectors, thereby improving the extent, accuracy and precision of grinding throughout grinding operations.

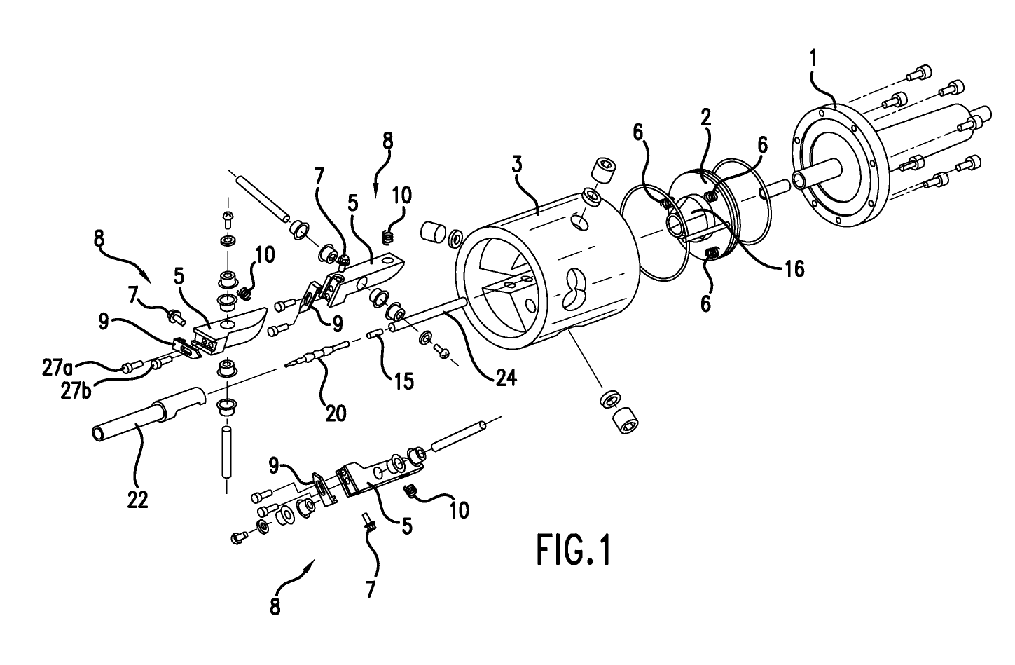

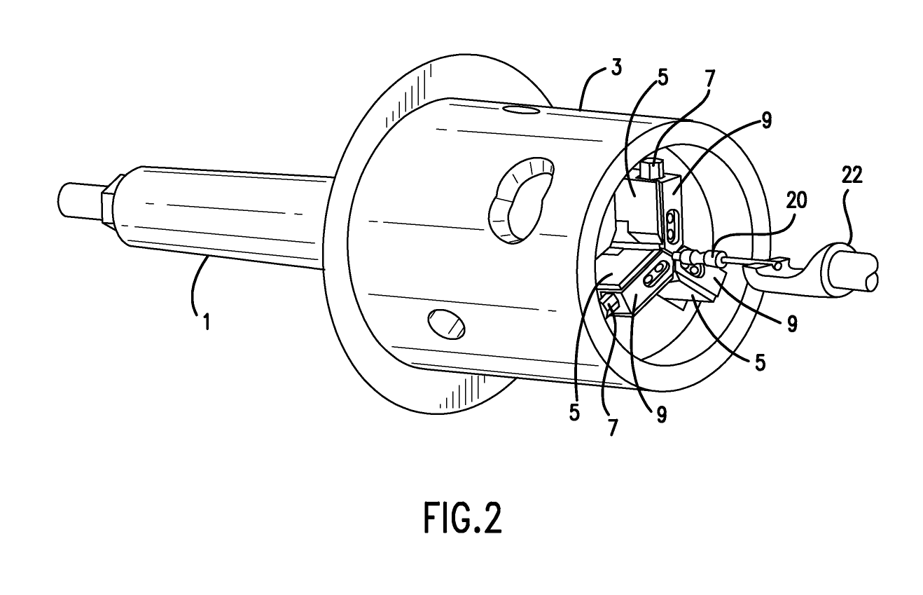

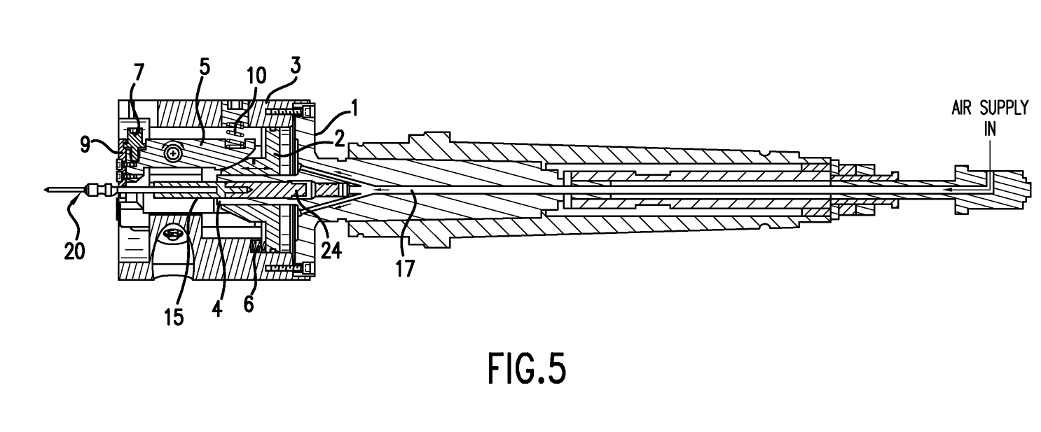

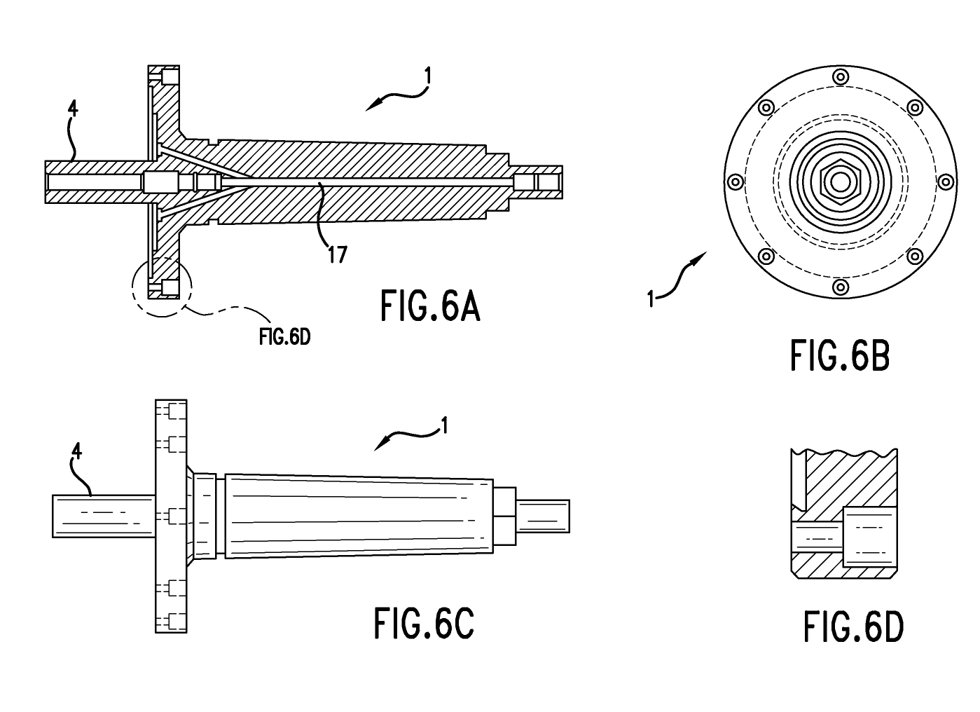

Referring now to FIGS. 1-6, an embodiment of a the chuck includes a mandrel 1. As shown, the mandrel has a #5 Morse taper to fit a standard work head of the grinding machine, although the taper can alternatively be another size, such as a #4 taper, or a flange mounting may be used. Mandrel 1 also serves as a base mounting for all other chuck components.

The chuck also includes a chuck housing 3, a piston 2 positioned for sliding guided movement on an extension 4 formed on mandrel 1, and three jaws 5 positioned in, and mounted on, housing 3. Housing 3 functions as the main chuck body, mounts to the mandrel 1, and houses jaws 5. Piston 2 is preferably air actuated but can be actuated by pressurized oil. Piston 2 moves axially along the chuck and mandrel extension 4 between extended and retracted positions to provide motion for, or cause movement of, the chuck jaws 5. Movement of piston 2 in a forward axial direction toward the extended position away from mandrel 1 causes jaws 5 to close or move toward a closed position. Movement of piston 2 in a reverse axial direction away from mandrel 1 causes jaws 5 to open or move toward an open position. One or more piston return springs 6, positioned between the housing and a piston flange, biases the piston 2 toward the retracted position away from housing 3 thereby moving the piston 2 in a reverse direction when the air or oil pressure is shut off.

Jaws 5 are each pivotally mounted on a jaw retaining assembly 8 (bushings, spacers and/or pins), as shown in FIG. 1, to pivot in a radial plane extending radially from the centerline axis of the housing 3. Each jaw 5 pivots around a pivot axis 11 extending perpendicular to the radial plane so that a clamping end of each jaw 5 moves in a clamping direction toward the centerline axis of the housing 3 when piston 2 moves toward its extended position.

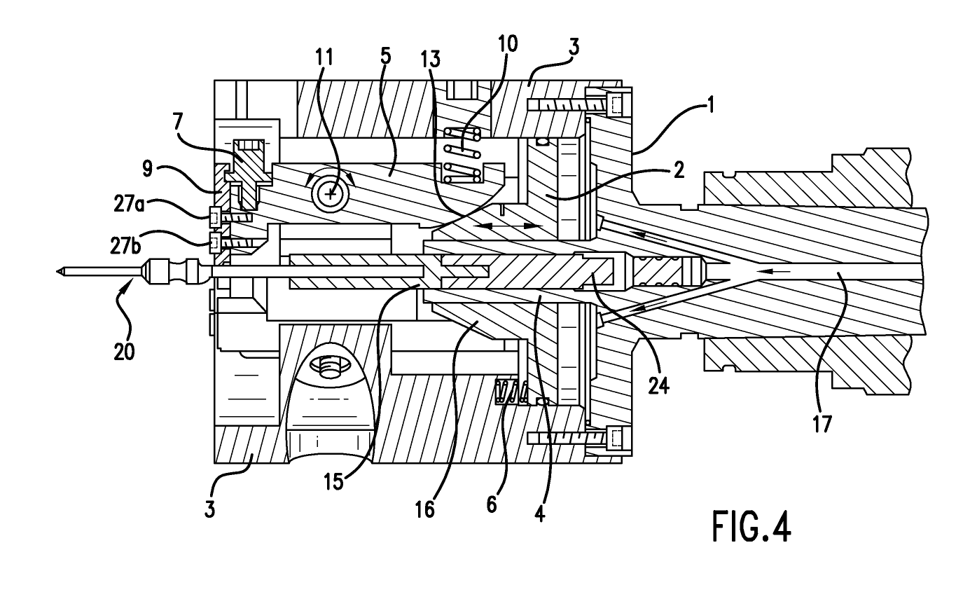

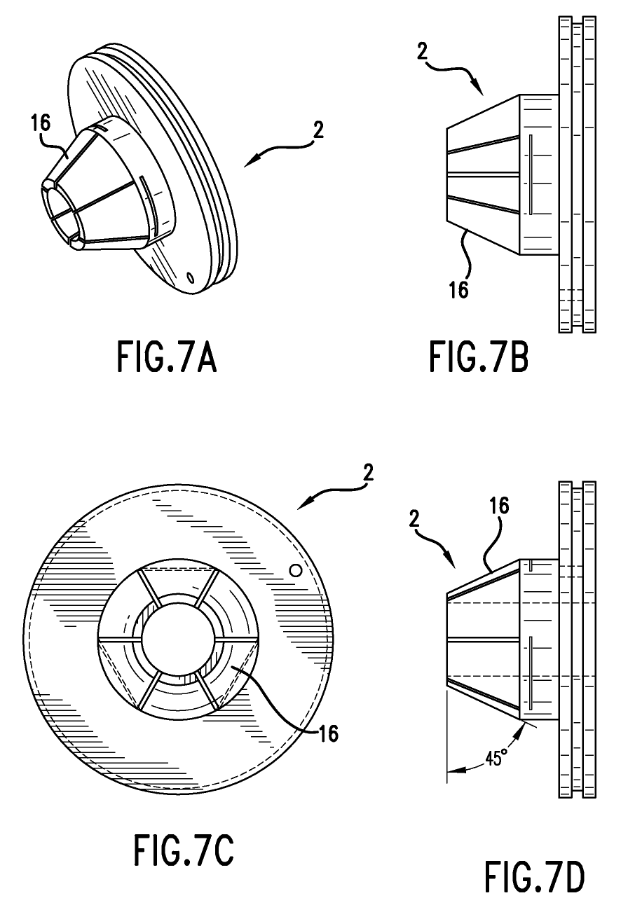

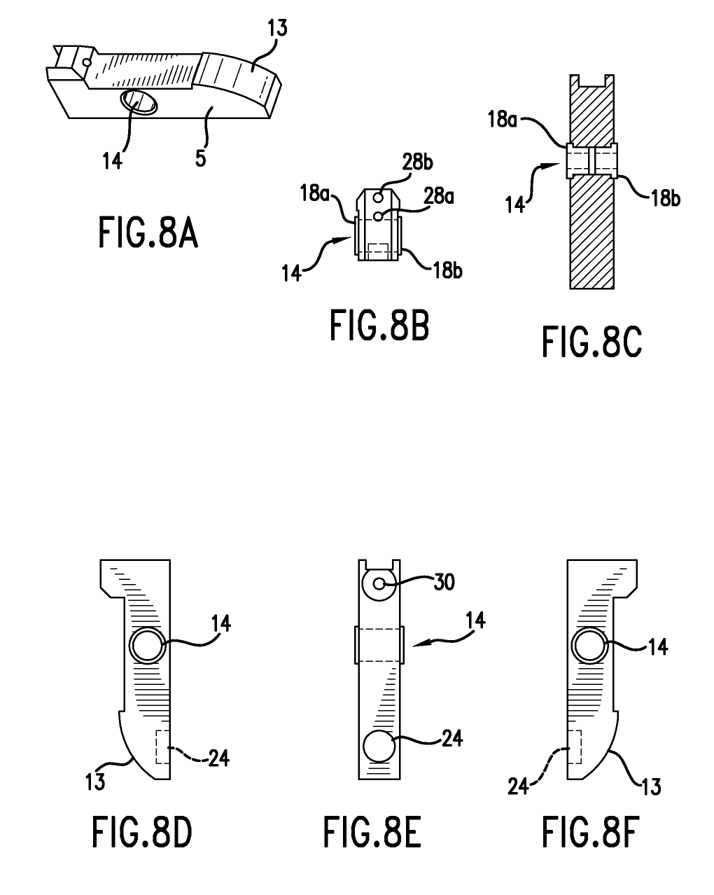

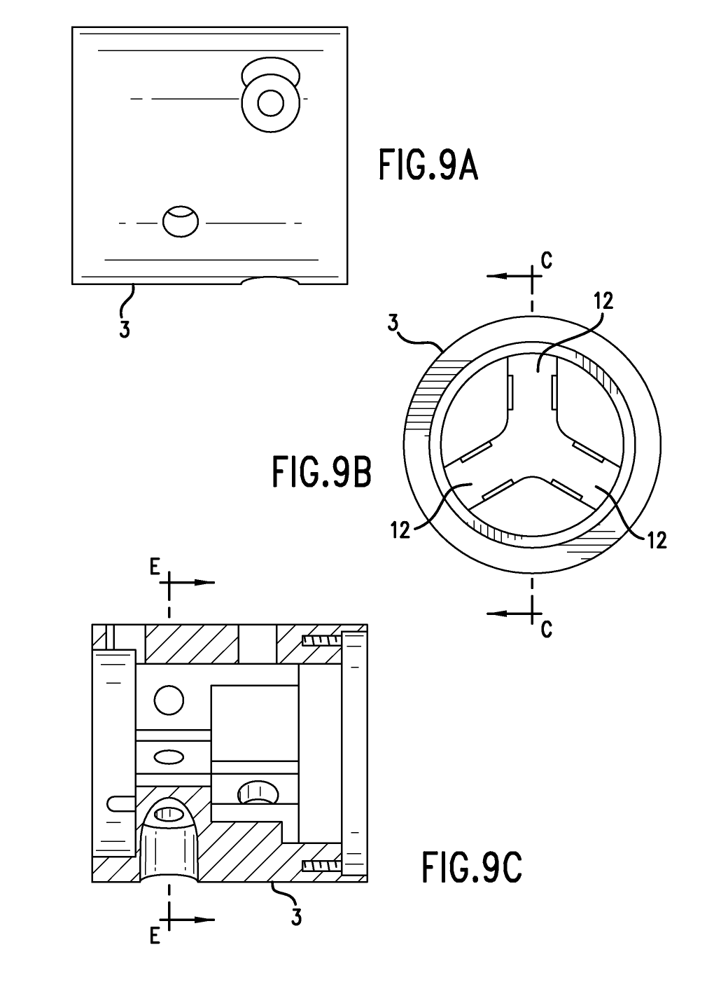

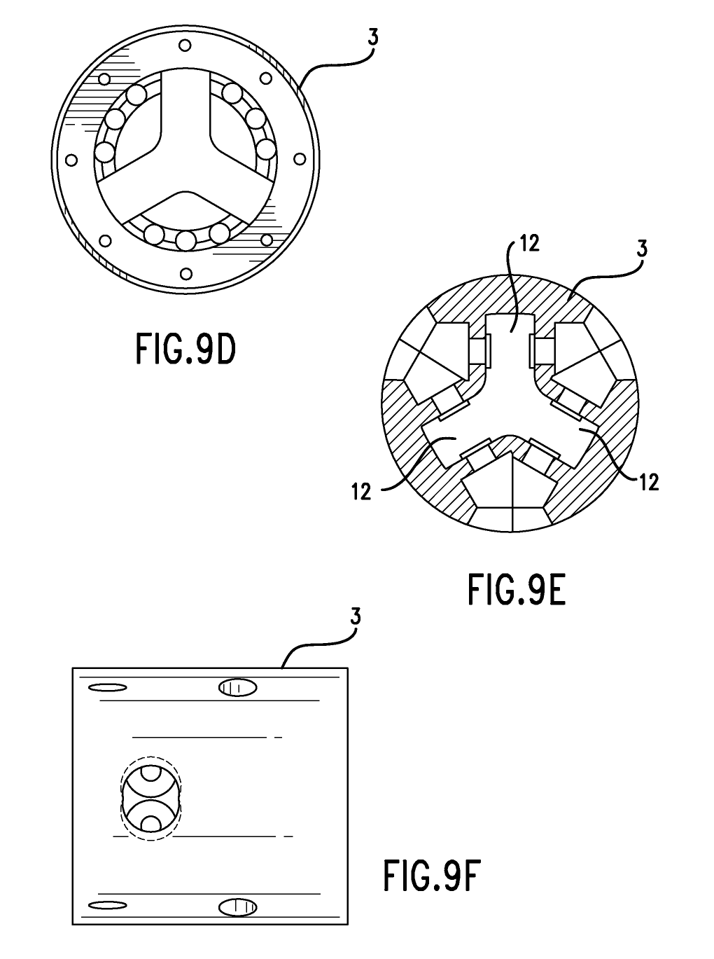

Referring now to the FIGS. 8A to 8F, which show more detailed views of an exemplary jaw 5, and FIGS. 9A to 9F, which show detailed views of an exemplary housing 3, the housing 3 includes three jaw slots 12 formed within the housing and spaced equally around the circumference of the interior of housing 3. Each jaw slot 12 is sized to receive and guide one of the jaws 5 during pivoting movement. Each jaw retaining assembly 8 (see also, FIG. 1) extends through the housing 3, a passage 14 formed in the respective jaw, and back into the housing 3 to pivotally mount and retain the jaw within the slot. Thus, jaws 5 can be mounted using precisely fitted bushings 18a, 18b to ensure stability and repeatability. Each jaw 5 also includes a driven end 13 having a curved inner surface for driven abutment or contact by a tapered portion 16 of a driving end of piston 2 (see, FIG. 4). Preferably the tapered portion is cone, or frusto-conically, shaped, for example, as shown in FIGS. 7A to 7D. A jaw return spring 10 is mounted at the driven end in a retaining opening 24 of each jaw to bias the driven end of the jaw toward and into abutment with the driving end of piston 2, and thus biasing jaw 5 toward a retracted position around pivot axis 11.

A part stop 24 is replaceably positioned within a conical bore formed in the mandrel extension to provide a fixed stop against which the workpiece or part, i.e. injector needle element, is positioned when inserting the part into the chuck. A plurality of interchangeable part stops having different length can be provided.

A replaceable jaw insert 6 may be provided on the clamping end of each jaw 5 to accommodate different clamping diameters. Jaw inserts can be attached to the top portion of each jaw 5 using screws 27a, 27b in openings 28a, 28b (see, FIGS. 4 and 8B) and are designed for quick change over (and replacement) to accommodate different work pieces. A jaw insert adjuster 7, mounted adjacent each insert 6 at 30 (see, FIG. 8E), permits the position of each insert 6 to be adjusted radially to achieve required run outs. This is accomplished by the jaw inserter adjuster 7.

Piston 2 is matched to the mandrel extension or arbor with a minimal clearance to permit smooth sliding yet well supported reciprocal movement. Piston 2 is also designed to collapse onto the mandrel in full closed position to provide stability and repeatability. Controlled air leakage thru the piston/mandrel clearance can be provided to reduce or prevent debris from entering cylinder chamber and ensure free sliding motion.

Jaw insert adjuster 7 is a micro adjusting screw to enable zeroing of the radial run out of the work piece to a desired accuracy. A set up detail (spider, not shown) is also designed to fit jaws for jaw grinding under a clamped condition if so desired. The spider is a ring with dowel pins that can be inserted into inner mounting holes of the jaw inserts so the jaws can be closed (clamped) for grinding of jaw inserts. Precisely adjusted jaws 5 will provide radial run out accuracy of 0.005 mm (or better) while maintaining a large range of opening clearance/motion (8 mm diametral) to accommodate different part geometries.

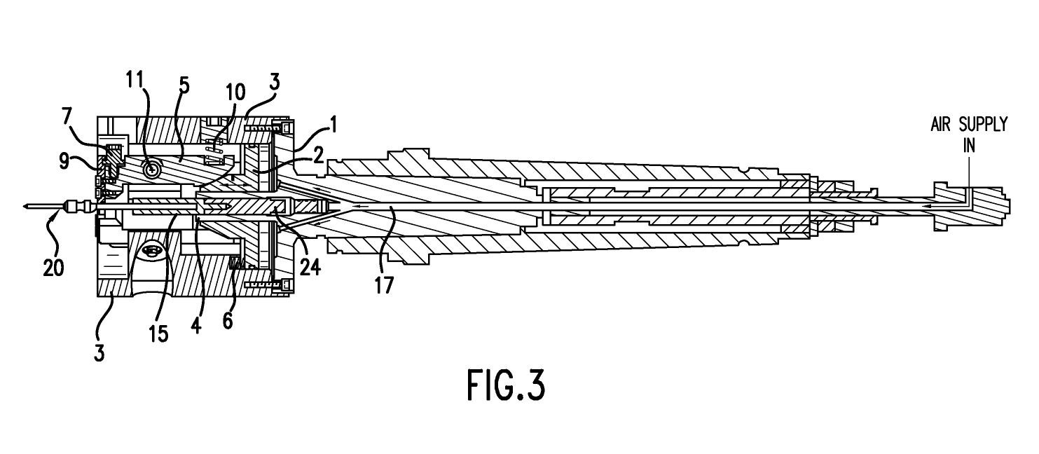

In use, the work piece or part 20 is inserted into the chuck against part stop 24. A part guide 15 may be used as a loading aid to help guide the part 20 into the chuck when manually clamping/loading. Air or pressurized oil is supplied to the piston area through a rotary coupling, air tube/passageway, and internal drillings. For example, FIGS. 3-6 show an air passageway 17, which splits into plural passageways before entering the area of the housing 3 near the piston 2. Upon supplying air pressure, piston 2 moves forward causing the jaws 5 to pivot and clamp the part. For parts that are required to protrude from the chuck, an auxiliary center support 22 can be used. To unclamp the work part, air supply to the chuck is shut off. With the air shut off, piston return springs 6 return piston 2 to its home position, and jaw return springs 10 pivot the jaws back into their home position.

A chuck mounted dressing disk may be used for wheel dressing. During chuck set-up, jaw inserts 6 are adjusted for required concentricity using jaw insert adjusting screws 7 and appropriate dial (or digital) indicator. This chuck can be used for precision grinding, turning, or whenever precise clamping of long and slender parts is required.

While an exemplary embodiment in accordance with the claimed invention has been shown and described, it is understood that the invention is not limited thereto. The present invention may be changed, modified and further applied by those skilled in the art. Therefore, this invention is not limited to the detail shown and described previously, but also includes all such changes and modifications within the scope of the following claims and their equivalents.

We claim:

1. A chuck assembly for holding a workpiece, comprising:
a piston mounted for movement;
a set of jaws mounted for pivotal movement, wherein movement of said piston causes pivotal movement of said set of jaws.

2. The chuck assembly of claim 1, where the piston includes a tapered portion to apply a driving force to at least one jaw of said set of jaws

3. The chuck assembly of claim 2, where said tapered portion is frusto-conically shaped.

4. The chuck assembly of claim 1, further comprising a passageway fluidly connected to a chamber including the piston, and said movement of said piston includes a clamping motion during which said jaws move toward a closed position with increasing pressure in the passageway.

5. The chuck assembly of claim 1, wherein the piston is biased to return the set of jaws to an open position with removal of fluid pressure from the passageway.

6. The chuck assembly of claim 1, further comprising a housing portion including a centerline axis, wherein each of the jaws pivot in a radial plane extending radially from the centerline axis of the housing.

7. The chuck assembly of claim 1, further comprising a mandrel portion, said mandrel portion including an extending member slidingly engaged with the piston.

8. The chuck assembly of claim 7, further comprising a mandrel portion, said mandrel portion including a tapered portion extending in a direction opposite the extending member.

9. The chuck assembly of claim 1, further comprising:
a housing including the piston and the set of jaws, and
a mandrel connected to the housing and including a passageway fluidly connected to an interior of the housing, wherein said piston movement is based on an amount of fluid pressure in the passageway.
